(19) United States
(12) Patent Application Publication
(10) Pub. No.: US 2022/0306085 A1
(43) Pub. Date: Sep. 29, 2022

(54) VEHICLE GUIDANCE SYSTEM AND VEHICLE GUIDANCE METHOD

(71) Applicant: Panasonic Intellectual Property Management Co., Ltd., Osaka (JP)

(72) Inventors: Yoshiki ITO, Osaka (JP); Tomonori UEMURA, Kyoto (JP); Kyouji TANAKA, Osaka (JP); Hirokazu TOKUDA, Osaka (JP); Isao NOGUCHI, Nara (JP)

(73) Assignee: Panasonic Intellectual Property Management Co., Ltd., Osaka (JP)

(21) Appl. No.: 17/667,837

(22) Filed: Feb. 9, 2022

(30) Foreign Application Priority Data
Mar. 24, 2021 (JP) 2021-049588

(51) Int. Cl. B60W 30/06; B60W 60/00; B60W 50/02

(52) U.S. Cl. CPC B60W 30/06; B60W 60/001; B60W 50/0205; B60W 2556/45; B60W 2050/0215

(57) ABSTRACT

A vehicle guidance system includes a hardware processor. The hardware processor specifies, outside a vehicle, a route from a starting position to a target position in a parking lot, and transmits, to the vehicle over a communication network, information about at least one route section of the route. The hardware processor determines detection accuracy of a first monitoring device being set as an active monitoring device out of monitoring devices. The active monitoring device serves to monitor deviation of the vehicle from the route section during autonomous driving along the route section. In response to determining that the detection accuracy of the first monitoring device is lower than a reference accuracy, the hardware processor sets a second monitoring device as the active monitoring device in place of the first monitoring device. The second monitoring device is different from the first monitoring device among the monitoring devices.

### CROSS-REFERENCE TO RELATED APPLICATIONS

This application is based upon and claims the benefit of priority from Japanese Patent Application No. 2021-049588, filed on Mar. 24, 2021, the entire contents of which are incorporated herein by reference.

### FIELD

The present disclosure relates to a vehicle guidance system and a vehicle guidance method.

### BACKGROUND

A guidance system for guiding a vehicle in a parking lot has been known (for example, Japanese Patent Application Laid-open No. 2018-502357). In this system for guiding a vehicle in a parking lot, a route in the parking lot from a starting position to a target position is specified outside the vehicle. Then, at least one route section of the specified route is transmitted to the vehicle over a communication network. Moreover, in this guidance method, deviation from the route section during autonomous driving along the route section by this vehicle is monitored by a monitoring system outside the vehicle.

However, in the method disclosed in the foregoing related art, when the accuracy of the monitoring system deteriorates, there is a possibility that the deviation of a vehicle during autonomous driving cannot be detected. When, in particular, a camera is used for the monitoring system, the detection accuracy may deteriorate in the case of rain or other bad weather, bringing about the possibility that the deviation of a vehicle during autonomous driving cannot be detected.

### SUMMARY

A vehicle guidance system according to the present disclosure includes a hardware processor. The hardware processor is configured to specify, outside a vehicle, a route from a starting position to a target position in a parking lot, and transmit, to the vehicle over a communication network, information about at least one route section of the route. The hardware processor is configured to determine detection accuracy of a first monitoring device being set as an active monitoring device out of monitoring devices each monitoring the vehicle. The active monitoring device serves to monitor deviation of the vehicle from the route section during autonomous driving along the route section. The hardware processor is configured to, in response to determining that the detection accuracy of the first monitoring device is lower than a reference accuracy, set a second monitoring device as the active monitoring device in place of the first monitoring device. The second monitoring device is different from the first monitoring device among the monitoring devices.

### BRIEF DESCRIPTION OF THE DRAWINGS

FIG. 1 is a block diagram illustrating a configuration of a vehicle guidance system according to an embodiment;

FIG. 2 is a diagram illustrating an automatic valet parking lot to which the vehicle guidance system according to the embodiment has been applied;

FIG. 3 is a flowchart illustrating vehicle guidance processing by the vehicle guidance system according to the embodiment; and

FIG. 4 is a diagram illustrating a hardware configuration of the vehicle guidance system according to the embodiment.

### DETAILED DESCRIPTION

An embodiment will be suitably described in detail with reference to the drawings. Note that excessively detailed descriptions will sometimes be omitted. For example, detailed descriptions of features which are already well known, or duplicate descriptions of substantially identical configurations are sometimes omitted. This is to avoid unnecessary redundancy in the following description and to facilitate understanding by a person skilled in the art.

Note that the accompanying drawings and the following description are provided to enable a person skilled in the art to sufficiently understand the present disclosure, and are not intended to limit the subject matter disclosed in the patent claims.

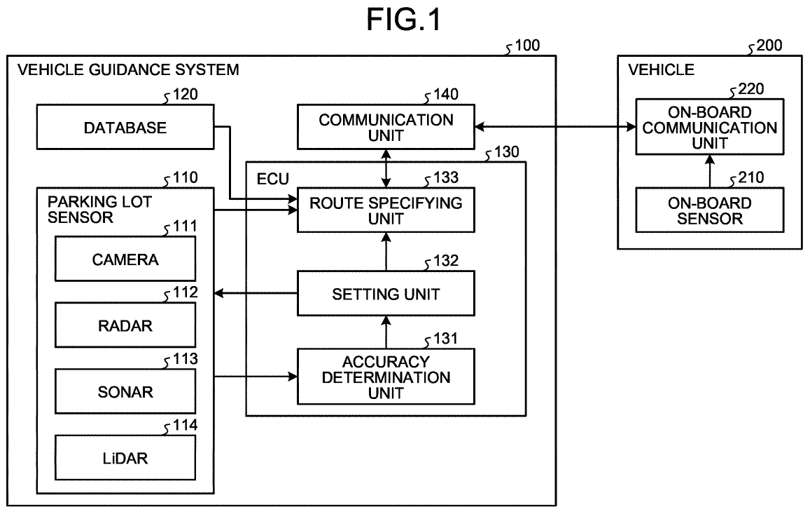

An embodiment will be described with reference to FIGS. 1 to 3.

### Configuration

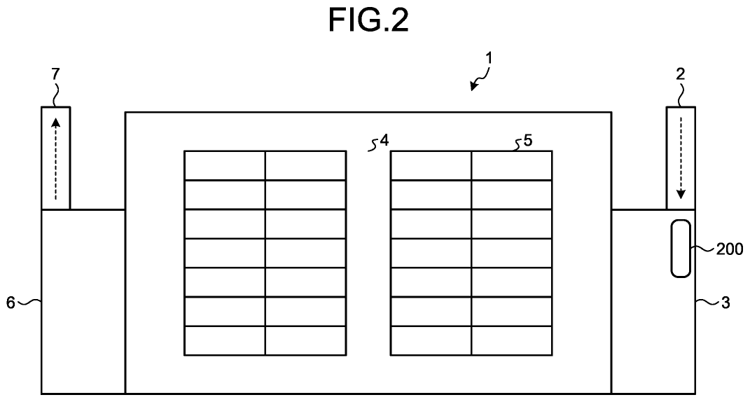

First, a configuration of a vehicle guidance system 100 according to the present embodiment will be described with reference to FIGS. 1 and 2.

FIG. 1 is a block diagram illustrating a configuration of the vehicle guidance system 100 according to an embodiment. The vehicle guidance system 100 is a system which is applied to an automatic valet parking lot 1 constituting a parking lot that provides so-called automatic valet parking. First, an overview of automatic valet parking will be provided.

FIG. 2 is a diagram illustrating an example of an automatic valet parking lot to which the vehicle guidance system has been applied.

Automatic valet parking refers to a system that enables a vehicle 200 to automatically drive and park itself under autonomous driving control after the occupant gets off from the vehicle. Specifically, the automatic valet parking causes, for example, the vehicle 200 to automatically park in a predetermined area within the automatic valet parking lot 1 after the occupant gets off from the vehicle 200 at a drop-off location 3 of the automatic valet parking lot 1, and also causes the vehicle 200 to automatically move to a boarding location 6 at the time of occupant boarding. The automatic valet parking lot 1 includes multiple parking areas 5. The parking areas 5 may each become an area of a parking target for the vehicle 200. The parking areas 5 are each provided within a frame demarcated by white lines on the premises, for example. The parking areas 5 have space where the vehicle 200 can park, and are arranged with a layout enabling the vehicle 200 to park.

Within the automatic valet parking lot 1, a driving path 4 allowing the vehicle 200 to drive is provided. Note that there may also be structures, such as shielding walls or support columns, within the automatic valet parking lot 1. The automatic valet parking lot 1 is provided with an entrance 2 for the vehicle 200 to enter, an exit 7 for the vehicle 200 to depart, the drop-off location 3 for the occupants to get off from the vehicle, a boarding location 6 for the occupants to board, and the like.

In automatic valet parking, the occupants get off from the vehicle 200 at the drop-off location 3 of the automatic valet parking lot 1. The occupants of the vehicle 200 include a driver of the vehicle 200. The vehicle 200 then enters the parking area 5 under autonomous driving control. At the time of parking exit, the vehicle 200 moves from the parking area 5 to the boarding location 6 under autonomous driving control. The occupants then board the vehicle 200 at the boarding location 6.

The autonomous driving control refers to control that allows the vehicle 200 to drive in a state without intervention by the driver. Under autonomous driving control, the vehicle 200 in the automatic valet parking lot 1 is driven from its current position to a preset target position in the automatic valet parking lot 1. The current position is the starting position of the autonomous driving control, for example, the foregoing drop-off location 3 or the parking area 5 where the vehicle 200 is currently parked. The target position is the end position of the autonomous driving control, for example, the parking area 5 or the boarding location 6. Parking control refers to control to park the vehicle 200 under autonomous driving control in a state without intervention by the driver.

Returning to FIG. 1, the description will now be resumed. The vehicle guidance system 100 according to the present embodiment is a system that performs parking control to park the vehicle 200 in the parking area 5. As illustrated in FIG. 1, the vehicle guidance system 100 is provided with a parking lot sensor 110, a database 120, an engine control unit (ECU) 130, and a communication unit 140. The ECU 130 is communicably connected to the database 120, the parking lot sensor 110, and the communication unit 140.

The parking lot sensor 110 includes a camera 111, a radar 112, sonar 113, light detection and ranging (LiDAR) 114, and other sensors (not illustrated). The camera 111, the radar 112, the sonar 113, and the LiDAR each detect the parking of the vehicle 200 at each of the drop-off location 3, the boarding location 6, the parking area 5, and the driving path 4. The parking lot sensor 110 outputs the detection results detected by these sensors to the ECU 130. The other sensors may include raindrop sensors, snow sensors, fog sensors, sunlight sensors, angular rate sensors, and the like, each being used in processing to determine detection accuracy described later.

Note that the vehicle guidance system 100 may be configured to include multiple sensors consisting of one or more of the cameras 111, the radars 112, the sonar 113, and the LiDAR 114, and other sensors. For example, the vehicle guidance system 100 may be configured to include two or more cameras 111. In this case, the cameras 111 may be arranged in different positions from each other in the automatic valet parking lot 1. In other words, an angle of view and a capturing direction of the cameras 111 may be adjusted in advance such that at least parts of their shooting ranges do not overlap with each other. Similarly, the radar 112, the sonar 113, the LiDAR 114, and the other sensors may be arranged such that at least parts of their detection ranges do not overlap in the case that the vehicle guidance system 100 is provided with multiple sensors.

The database 120 stores, for example, map data of the automatic valet parking lot 1, that is, data indicating the locations of the parking area 5, the driving path 4, and the like. The database 120 is configured to enable the ECU 130 to reference the database.

The ECU 130 is an example of the “hardware processor”. The ECU 130 may be an electronic control unit that includes a central processing unit (CPU), a read-only memory (ROM), a random-access memory (RAM), and the like. The ECU 130 implements various functions by, for example, operating a CAN communication circuit to input and output data on the basis of signals output by the CPU, storing data in the RAM, loading programs stored in the ROM into RAM, and executing programs loaded into the RAM. The ECU 130 may also be configured by a plurality of electronic control units.

The ECU 130 includes an accuracy determination unit 131, a setting unit 132, and a route specifying unit 133.

The route specifying unit 133 specifies, outside the vehicle 200, a route in the automatic valet parking lot 1 from a starting position to a target position.

More precisely, the route specifying unit 133 recognizes the parking status of the automatic valet parking lot 1 on the basis of the detection results detected by the parking lot sensor 110. The parking status of the automatic valet parking lot 1 includes, for example, information about one or more parking areas 5 where the vehicle 200 is parked and information about one or more parking areas 5 where the vehicle 200 is not parked, that is, vacancy information.

The route specifying unit 133 recognizes the vehicle 200 that has arrived at the drop-off location 3 of the automatic valet parking lot 1 on the basis of the detection results detected by the parking lot sensor 110.

The route specifying unit 133 specifies the route of the vehicle 200 at the time of parking entry and exit on the basis of the recognized parking status of the vehicle 200 and of the automatic valet parking lot 1, as well as the map data of the automatic valet parking lot 1. The route includes, for example, the parking entry route being a route on the driving path 4 from the drop-off location 3 to the parking area 5, and also includes the exit route being a route on the driving path 4 from the parking area 5 to the boarding location 6. The route specifying unit 133 transmits the information about the specified route to the vehicle 200 through the communication unit 140.

The vehicle guidance system 100 according to the present embodiment is configured such that the route specified by the route specifying unit 133 is divided into multiple sections, and information about the route is transmitted to the vehicle 200 for each of the divided sections.

The accuracy determination unit 131 determines the detection accuracy of the parking lot sensor 110. In other words, the accuracy determination unit 131 determines the detection accuracy of the camera 111, the radar 112, the sonar 113, the LiDAR 114, and an on-board sensor 210 which are included in the parking lot sensor 110. According to the present embodiment, the accuracy determination unit 131 determines, in particular, the detection accuracy of the camera 111.

The camera 111, the radar 112, the sonar 113, the LiDAR 114, and the on-board sensor 210 according to the present embodiment are examples of the “monitoring devices” in the patent claims. The camera 111 according to the present embodiment is an example of the “first monitoring device” in the patent claims.

Moreover, another camera 111, which is different from the camera 111 serving as the first monitoring device, the radar 112, the sonar 113, the LiDAR 114, or the on-board sensor 210 according to the present embodiment are each examples of the “second monitoring device” in the patent claims. Details of the determination of the detection accuracy by the accuracy determination unit 131 will be described later.

The setting unit 132 sets an active monitoring device. The active monitoring device is a monitoring device that is currently selected to serve to monitor the deviation brought about by the vehicle 200. In the vehicle guidance system 100, the monitoring device which has been set by the setting unit 132 as the active monitoring device monitors deviation in the vehicle 200. Note that, in an initial state, the first monitoring device is assumed to be set as the active monitoring device.

The setting unit 132 selects one sensor from among the parking lot sensor 110 and the on-board sensor 210 described later, on the basis of the determination result by the accuracy determination unit 131, and sets the selected sensor as the active monitoring device. Details of the setting by the setting unit 132 of the active monitoring device will be provided subsequently.

The communication unit 140 communicates with the vehicle 200 by road-to-vehicle communication. The communication unit 140 receives and outputs various signals from and to the ECU 130. In the present embodiment, the communication unit 140 transmits, to the vehicle 200 over a communication network, at least one section of the route specified by the route specifying unit 133.

The vehicle 200 includes an on-board communication unit 220 and an on-board sensor 210.

The on-board sensor 210 includes, for example, a sensor for detecting obstacles or objects such as white lines, which exist in the vicinity of the vehicle 200, and a sensor for acquiring position information indicating the position of the vehicle 200. Sensors that detect objects in the vicinity of the vehicle 200 include, for example, cameras, radar, sonar, or LiDAR. Sensors that acquire positional information indicating the position of the vehicle 200 include sensors such as a global navigation satellite system (GNSS) that are capable of specifying coordinates, that is, the latitude and longitude, of the vehicle 200 within the automatic valet parking lot 1.

The on-board communication unit 220 communicates with the communication unit 140 of the vehicle guidance system 100 through road-to-vehicle communication.

The vehicle 200 receives information about at least one section of the route in the parking lot from the starting position to the target position, the information being transmitted from the vehicle guidance system 100. The vehicle 200 then moves autonomously along the received route section. The vehicle 200 implements the automatic valet parking by moving autonomously along sections which are sequentially transmitted from the vehicle guidance system 100. For example, the vehicle 200 moves autonomously from the drop-off location 3 to the parking area 5 of the automatic valet parking lot 1 by moving autonomously along the route sections.

The camera 111, which is an example of the first monitoring device, monitors deviation of the vehicle 200 from the route section during autonomous driving of the vehicle 200 along the route section.

The first monitoring device, which is set as the active monitoring device by the setting unit 132, identifies occurrence of the deviation of the vehicle 200. For example, it is assumed that deviation of the vehicle 200 is identified by the camera 111, which serves as the first monitoring device. In this case, the route specifying unit 133 specifies a solution route to resolve the deviation. Known methods may be used to specify the solution route. The communication unit 140 then transmits information about the specified solution route to the vehicle 200 over the communication network. The vehicle 200 can resolve the deviation by moving along the solution route.

By the way, the detection accuracy of the first monitoring device, which is set as the active monitoring device, deteriorates in some cases. In such cases, there is a possibility that the deviation of the vehicle 200 during autonomous driving cannot be detected. Therefore, in the vehicle guidance system 100 according to the present embodiment, the setting unit 132 sets the first monitoring device as the active monitoring device when the detection accuracy of the first monitoring device is determined to be equal to or larger than a reference accuracy. On the other hand, when the detection accuracy of the first monitoring device is determined to be lower than the reference accuracy, the setting unit 132 sets, as the active monitoring device, a second monitoring device out of the monitoring devices, which is different from the first monitoring device. Such processing will now be described in detail.

### Determination of Detection Accuracy

The processing to determine the detection accuracy of the camera 111, which is an example of the first monitoring device, by the accuracy determination unit 131 will be described while exemplifying assumed factors that may cause deterioration of the detection accuracy.

The accuracy determination unit 131 determines the detection accuracy of the camera 111 on the basis of, for example, at least one of the following: the weather, a shift in the capturing direction of the camera 111, dirt on the lens surface of the camera 111, shake of the camera 111, and failure of the camera 111.

(1) Weather

The accuracy determination unit 131 determines the detection accuracy of the camera 111 on the basis of weather information. Specifically, the accuracy determination unit 131 determines, on the basis of the weather information, that the detection accuracy of the camera 111 is lower than the reference accuracy when a predetermined condition is satisfied. For example, the accuracy determination unit 131 determines the detection accuracy of the camera 111 on the basis of weather information for the automatic valet parking lot 1 as detected by the other sensors included in the parking lot sensor 110. In this case, the other sensors include raindrop sensors, snow sensors, fog sensors, and sunlight sensors, and the like.

The accuracy determination unit 131 determines that the above predetermined condition is satisfied in the following situation: the raindrop sensor or the snow sensor detects rainy weather or snowy weather, the fog sensor detects presence of fog, or the sunlight sensor detects that the illuminance around the camera 111 is lower than a set value. The set value may also be predefined. The set value may also be changed, as needed, in accordance with an operational instruction by the user. The set value is an example of a “first set value”.

The accuracy determination unit 131 may also determine, on the basis of the images captured by the camera 111, that the detection accuracy of the camera 111 is lower than the reference accuracy when the rainy or snowy weather, the presence of fog, or the surroundings becoming dark due to sunset is detected.

The accuracy determination unit 131 may also determine, on the basis of the weather information received by the other sensors, that the detection accuracy of the camera 111 is lower than the reference accuracy when the rainy or snowy weather, the presence of fog, or the surroundings becoming dark due to sunset is detected. In this case, the other sensors include a device that receives such meteorology information from known information processing devices which distribute meteorology information including weather information.

Alternatively, the accuracy determination unit 131 may determine the detection accuracy of the camera 111 on the basis of time information. In this case, the other sensors include a device that receives sunset time information from the information processing devices and the like that distribute the sunset time information. The accuracy determination unit 131 compares the current time with the sunset time, and when the current time is later than the sunset time, predicts that the sun has set and the surroundings are dark, and determines that the detection accuracy of the camera 111 is lower than the reference accuracy.

(2) Shift in Capturing Direction

The accuracy determination unit 131 determines the detection accuracy of the camera 111 on the basis of the amount of shift in a capturing direction of the camera 111. The accuracy determination unit 131 stores a pattern and a position of a visual target in the image data captured in advance by the camera 111. Using the image data newly captured by the camera 111 and the visual target pattern data, the accuracy determination unit 131 extracts a pattern of the visual target in the image data by using a pattern recognition method such as the template matching method. The accuracy determination unit 131 then detects the position of the extracted visual target and compares the position of the detected visual target with a pre-stored index position. The amount of shift in the position of the visual target is derived, and thus the amount of shift in the capturing direction of the camera 111 is obtained. When the amount of shift in the capturing direction of the camera 111 is larger than a set value, the accuracy determination unit 131 determines that the detection accuracy of the camera 111 is lower than the reference accuracy. The set value may also be predefined. This set value may also be changed, as needed, according to an operational instruction by the user. The set value is an example of a “second set value”.

(3) Dirt on Lens Surface

The accuracy determination unit 131 determines the detection accuracy of the camera 111 on the basis of dirt on the lens surface of the camera 111. When dirt or the like sticks on the lens surface of the camera 111, there will be almost no difference in pixel values in the area corresponding to the dirt between image data captured by the camera 111 at different capture times. Therefore, the accuracy determination unit 131 determines the detection accuracy of the camera 111 by detecting differences between the image data captured by the camera 111. The accuracy determination unit 131 detects the ratio of the number of pixels in an area where no difference arises over a given period to the number of pixels in the whole image. Further, when the percentage of pixels with no difference is larger than a given percentage, the accuracy determination unit 131 predicts that dirt on the lens surface of the camera 111 covers a portion of the lens surface that is larger than the given percentage, and determines that the detection accuracy of the camera 111 is lower than the reference accuracy.

(4) Shake of Camera

The accuracy determination unit 131 determines the detection accuracy of the camera 111 on the basis of the amount of shake of the camera 111. For example, the accuracy determination unit 131 determines the detection accuracy of the camera 111 on the basis of information about the shake detected by the other sensors included in the parking lot sensor 110. In this case, the other sensors include an angular rate sensor or the like. The angular rate sensor detects how much the angle of the camera 111 changes per unit time, that is, detects the amount of shake of the camera 111. The accuracy determination unit 131 determines that the detection accuracy of the camera 111 is lower than the reference accuracy when the amount of shake of the camera 111 detected by the angular rate sensor is larger than a set value. The set value may also be predefined. This set value may also be changeable.

The accuracy determination unit 131 may also determine that the detection accuracy of the camera 111 is lower than the reference accuracy in response to determining that the amount of shake of the camera 111 is larger than the set value on the basis of the shake in the image captured by the camera 111. The set value may also be predefined. This set value may also be changeable. The set value for the amount of shake of the camera 111 is an example of a “third set value”.

Alternatively, the accuracy determination unit 131 may determine the detection accuracy of the camera 111 on the basis of earthquake information. In this case, the other sensors include seismographs and devices that receive the earthquake information from an information processing device that distributes earthquake information. The accuracy determination unit 131 determines that the detection accuracy of the camera 111 is lower than the reference accuracy when the amount of shake of the camera 111 is determined to be equal to or larger than a given threshold value on the basis of the earthquake information, or when the amount of the shake is predicted to be equal to or larger than a given threshold value.

Alternatively, the accuracy determination unit 131 may determine the detection accuracy of the camera 111 on the basis of wind information. In this case, the other sensors include wind gauges and devices that receive such wind information from an information processing device distributing wind information. The accuracy determination unit 131 determines that the detection accuracy of the camera 111 is lower than the reference accuracy when the amount of shake of the camera 111 is determined to be equal to or larger than a given threshold value on the basis of the wind information, or when the amount of the shake is predicted to be equal to or larger than a given threshold value.

(5) Failure

The accuracy determination unit 131 determines the detection accuracy of the camera 111 on the basis of whether or not the camera 111 is failing. For example, the accuracy determination unit 131 detects that there is no response from the camera 111 for a predetermined period or more in communication with the camera 111, or detects abnormalities from the image, such as half of the image captured by the camera 111 not being captured. When such a situation is detected, the accuracy determination unit 131 recognizes that the camera 111 is failing, and then determines that the detection accuracy of the camera 111 is lower than the reference accuracy.

### Setting of Active Monitoring Device

The processing by the setting unit 132 to set the active monitoring device will be described below. First, the accuracy determination unit 131 specifies a factor causing a low reference accuracy in response to determining that the detection accuracy of the camera 111 as the first monitoring device, which is currently set to be the active monitoring device, is lower than the reference accuracy. The setting unit 132 then sets the second monitoring device on the basis of the specified factor. Specifically, the setting unit 132 selects, as the second monitoring device, one of sensors in the parking lot sensor 110 other than the camera 111 or the on-board sensor 210, each does not have the specified factor. The setting unit 132 then sets the selected second monitoring device as the new active monitoring device.

The setting of the second monitoring device by the setting unit 132 will be described in correspondence with the factors for the degradation of the detection accuracy as mentioned in the description of the “Determination of Detection Accuracy” above.

(1) Weather

It is assumed that the accuracy determination unit 131 determines that the detection accuracy of the camera 111 is lower than the reference accuracy due to the weather. In this case, the setting unit 132 selects another parking lot sensor 110 or on-board sensor 210, each of whose detection range includes the route section where the camera 111 was capturing. The setting unit 132 then sets the selected parking lot sensor 110 as the second monitoring device.

More specifically, for example, the setting unit 132 determines whether or not there is a camera 111 out of the other cameras 111 installed in the automatic valet parking lot 1, which is not affected by the weather and is different from the camera 111 that is currently set as the active monitoring device. In response to determining that there is such another camera 111, the setting unit 132 then selects this camera 111 and sets it as the second monitoring device. Specifically, the setting unit 132 selects the other camera 111 whose detection accuracy has been determined to be equal to or larger than the reference accuracy, and determines this camera 111 as the second monitoring device. The setting unit 132 then sets the selected second monitoring device as the new active monitoring device.

For example, it is assumed that the detection accuracy of the camera 111, which is currently set as the active monitoring device, is lower than the reference accuracy due to rain falling. Another camera 111 installed under roofs and the like is less susceptible to the influence of rain. Therefore, in this case, the setting unit 132 selects another camera 111 installed under this roof and sets the selected camera 111 as the second monitoring device.

The setting unit 132 may select the radar 112, the sonar 113, or the LiDAR 114 each being installed in the automatic valet parking lot 1, and then set the selected one as the second monitoring device. In general, a radar, sonar, and LiDAR each have a higher detection accuracy than the camera 111 during rain and fog, and at night. Therefore, the setting unit 132 may select one of these sensors and set the selected one as the second monitoring device.

Alternatively, the setting unit 132 may select the on-board sensor 210 installed in the vehicle 200 and set the on-board sensor 210 as the second monitoring device. As a result, the surroundings of the vehicle 200 can be detected with a higher detection accuracy than the case of using the camera 111.

(2) Shift in Capturing Direction

It is assumed that the accuracy determination unit 131 determines that the detection accuracy of the camera 111 is lower than the reference accuracy due to a shift in the capturing direction of the camera 111. In this case, the setting unit 132 selects another sensor of the parking lot sensor 110 or the on-board sensor 210, each of whose detection range includes the route section where the camera 111 was capturing. The setting unit 132 then sets the selected parking lot sensor 110 or on-board sensor 210 as the second monitoring device. Note that the area that can be captured by the camera 111, whose capturing direction has shifted, may also be captured by this camera 111. Then, an area that cannot be captured due to a shift in the capturing direction of the camera 111 may be detected by another parking lot sensor 110 or the on-board sensor 210. In this case, the setting unit 132 selects the camera 111 and either one of another sensor of the parking lot sensor 110 or the on-board sensor 210. The setting unit 132 then sets the camera 111 and the selected one as the second monitoring device.

The setting unit 132 may, for example, selects another camera 111 for capturing a section adjacent to the route section where the camera 111 was capturing, and sets the selected camera 111 as the second monitoring device. Furthermore, the setting unit 132 selects the radar 112, the sonar 113, or the LiDAR installed in the automatic valet parking lot 1, or the on-board sensor 210 provided in the vehicle 200. The setting unit 132 sets the selected monitoring device as the second monitoring device.

(3) Dirt on Lens Surface

It is assumed that the accuracy determination unit 131 determines that the detection accuracy of the camera 111 is lower than the reference accuracy due to dirt on the lens surface of the camera 111. In this case, the setting unit 132 selects another parking lot sensor 110 or on-board sensor 210, each of whose detection range includes the route section where the camera 111 was detecting. The setting unit 132 then sets the selected parking lot sensor 110 or on-board sensor 210 as the second monitoring device. The setting unit 132 determines whether or not there is a camera 111 out of the other cameras 111 installed in the automatic valet parking lot 1, which is not affected by the dirt on the lens surface and is different from the camera 111 whose lens surface is soiled with dirt. Then, in response to determining that there is such a camera 111, the setting unit 132 selects this camera 111 and sets the selected camera 111 as the second monitoring device. In other words, the setting unit 132 selects the other camera 111 whose detection accuracy is determined to be equal to or larger than the reference accuracy and sets the selected camera 111 as the second monitoring device. The setting unit 132 then sets the selected second monitoring device as the new active monitoring device.

Moreover, the setting unit 132 may select the radar 112, the sonar 113, or the LiDAR 114 installed in the automatic valet parking lot 1, or the on-board sensor 210 provided in the vehicle 200, and set the selected one as the second monitoring device.

(4) Shake of Camera

It is assumed that the accuracy determination unit 131 determines that the detection accuracy of the camera 111 is lower than the reference accuracy due to shake of the camera 111. In this case, the setting unit 132 selects another parking lot sensor 110 or on-board sensor 210, each of whose detection range includes the route section where the camera 111 was detecting. The setting unit 132 then sets the selected parking lot sensor 110 or on-board sensor 210 as the second monitoring device. The setting unit 132 determines whether or not there is a camera 111 out of the other cameras 111 installed in the automatic valet parking lot 1, which is not affected by the shake and is different from the camera 111 from which the shake was detected. Then, in response to determining that there is such a camera 111, the setting unit 132 selects this camera 111 and sets the selected camera 111 as the second monitoring device. In other words, the setting unit 132 selects the other camera 111 whose detection accuracy has been determined to be equal to or larger than the reference accuracy and sets the selected camera 111 as the second monitoring device. The setting unit 132 then sets the selected second monitoring device as the new active monitoring device.

Moreover, the setting unit 132 may select the radar 112, the sonar 113, or the LiDAR 114 installed in the automatic valet parking lot 1, or the on-board sensor 210 provided in the vehicle 200, and set the selected one as the second monitoring device.

(5) Failure

It is assumed that the accuracy determination unit 131 determines that the detection accuracy of the camera 111 is lower than the reference accuracy due to failure of the camera 111. In this case, the setting unit 132 selects another parking lot sensor 110 or on-board sensor 210, each of whose detection range includes the route section where the camera 111 was detecting. The setting unit 132 then sets the selected parking lot sensor 110 or on-board sensor 210 as the second monitoring device. When there is a camera 111 differing from the failed camera 111 out of the other cameras 111 installed in the automatic valet parking lot 1, which is not affected by failure, the setting unit 132 selects this camera 111 and sets the selected camera 111 as the second monitoring device. In other words, the setting unit 132 selects the other camera 111 whose detection accuracy has been determined to be equal to or larger than the reference accuracy and sets the selected camera 111 as the second monitoring device. The setting unit 132 then sets the selected second monitoring device as the new active monitoring device.

Moreover, the setting unit 132 may select the radar 112, the sonar 113, or the LiDAR 114 installed in the automatic valet parking lot 1, or the on-board sensor 210 provided in the vehicle 200, and set the selected one as the second monitoring device. In particular, selecting the on-board sensor 210 is useful when all the parking lot sensors 110 have failed due to a disaster or the like.

In addition to the above-described items (1) to (5), the setting unit 132 may select, for example, either the parking lot sensor 110 or the on-board sensor 210, which corresponds to a section other than the route section that was captured by the camera 111 whose detection accuracy was determined as being lower than the reference accuracy by the accuracy determination unit 131. In this case, the accuracy of the vehicle guidance by the vehicle guidance system 100 can be improved by that, the route specifying unit 133 specifies a route which does not include the route section captured by the camera 111 having the lower detection accuracy.

### Processing Operation

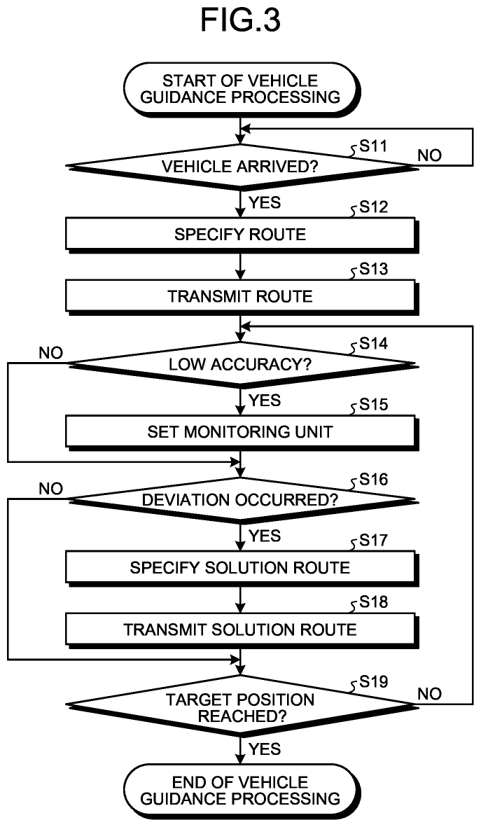

The processing operation for the vehicle guidance by the vehicle guidance system 100 will be described with reference to FIG. 3.

First, in Step S11, the route specifying unit 133 determines whether or not the vehicle 200 has arrived at the automatic valet parking lot 1. Specifically, the route specifying unit 133 determines, on the basis of the detection results of the camera 111, whether or not the vehicle 200 has arrived at the automatic valet parking lot 1 by determining whether or not the vehicle 200 has been recognized as having arrived at the drop-off location 3. In response to determining by the route specifying unit 133 that the vehicle 200 has arrived at the automatic valet parking lot 1 (Yes in Step S11), the processing advances to Step S12.

On the other hand, when it has not been determined by the route specifying unit 133 that the vehicle 200 has arrived at the automatic valet parking lot 1 (No in Step S11), the processing of Step S11 is executed again.

In Step S12, the route specifying unit 133 specifies a route for parking the vehicle 200 in the parking area 5. The route specifying unit 133 recognizes the parking status of the automatic valet parking lot 1 on the basis of the detection results of the camera 111 and sets a parking area 5 as the target position where parking is available. Furthermore, the route specifying unit 133 reads the map data of the automatic valet parking lot 1 stored in the database 120. The route specifying unit 133 specifies the route from the drop-off location 3 to the target position, on the basis of the recognized parking status of the automatic valet parking lot 1 and the map data of the automatic valet parking lot 1. The route specifying unit 133 outputs the information about the specified route to the communication unit 140. The processing then advances to Step S13.

In Step S13, the communication unit 140 transmits the information about the route, which was output from the route specifying unit 133, to the vehicle 200. The processing then advances to Step S14.

In Step S14, the accuracy determination unit 131 determines whether or not the detection accuracy of the camera 111 as the first monitoring device is lower than the reference accuracy. The accuracy determination unit 131 acquires the detection results of the camera 111 from this camera 111 and determines whether or not the detection accuracy of the camera 111 is lower than the reference accuracy on the basis of the detection results. In response to determining that the detection accuracy of the camera 111 is lower than the reference accuracy (Yes in Step S14), the accuracy determination unit 131 gives the setting unit 132 a notification that the detection accuracy of the camera 111 is lower than the reference accuracy. In addition, the accuracy determination unit 131 gives the setting unit 132 a notification of the factor causing the detection accuracy of the camera 111 to be lower than the reference accuracy. The processing then advances to Step S15.

In Step S15, the setting unit 132 sets the active monitoring device. Specifically, on the basis of the factor causing the detection accuracy of the camera 111 as the first monitoring device to be lower than the reference accuracy, as notified by the accuracy determination unit 131, the setting unit 132 selects one sensor from among the parking lot sensor 110 and the on-board sensor 210, excluding the camera 111 as the first monitoring device. Then, the setting unit 132 sets the selected one sensor as the second monitoring device, and sets the second monitoring device as the new active monitoring device. The setting unit 132 gives the route specifying unit 133 a notification of the new active monitoring device. The processing then advances to Step S16.

On the other hand, in response to determining that the detection accuracy of the camera 111 as the first monitoring device is equal to or larger than the reference accuracy (No in Step S14), the accuracy determination unit 131 gives the setting unit 132 a notification that the detection accuracy of the camera 111 is equal to or larger than the reference accuracy. In this case, the setting unit 132 sets the camera 111, which is the first monitoring device, as the active monitoring device, and gives the route specifying unit 133 a notification that the camera 111 is still set as the active monitoring device. The processing then advances to Step S16.

In Step S16, the monitoring device set as the active monitoring device monitors the vehicle 200 for whether or not the vehicle 200 deviates from the route. In other words, the active monitoring device monitors the vehicle 200 to determine whether or not the vehicle 200 is following the route accurately while driving, that is, whether or not there is a difference between the route specified by the route specifying unit 133 and the trajectory actually traveled by the vehicle. Upon detecting the deviation of the vehicle 200 which is moving along the route (Yes in Step S16), the active monitoring device gives the route specifying unit 133 a notification that the vehicle 200 has deviated from the route. The processing then advances to Step S17.

In Step S17, the route specifying unit 133 specifies a solution route for the vehicle 200 to resolve the deviation. The route specifying unit 133 recognizes the status of the automatic valet parking lot 1 on the basis of the detection results of the active monitoring device. Then, the route specifying unit 133 specifies the solution route on the basis of the recognized status of the automatic valet parking lot 1. The route specifying unit 133 outputs the information about the specified solution route to the communication unit 140. The processing then advances to Step S18.

In Step S18, the communication unit 140 transmits, to the vehicle 200, the information about the solution route output by the route specifying unit 133. The processing then advances to Step S19.

On the other hand, when the active monitoring device does not detect any deviation of the vehicle 200 being moving along the route (No in Step S16), the monitoring device gives the route specifying unit 133 a notification that the vehicle 200 has not deviated from the route. The processing then advances to Step S19.

In Step S19, the route specifying unit 133 determines whether or not the vehicle 200 has reached the target position. The route specifying unit 133 determines whether or not the vehicle 200 has reached the target position on the basis of the detection results of the active monitoring device. In response to determining by the route specifying unit 133 that the vehicle 200 has reached the target position (Yes in Step S19), the vehicle guidance processing by the vehicle guidance system 100 ends.

On the other hand, when it is not determined by the route specifying unit 133 that the vehicle 200 has reached the target position (No in Step S19), the processing returns to Step S14, and the processing from Step S14 onward is executed.

Note that, while the vehicle guidance processing at the time of parking entry has been described, the vehicle guidance processing is also executed at the time of parking exit. At the time of parking entry, the route specifying unit 133 determines in Step S11 whether or not the vehicle 200 has arrived at the automatic valet parking lot 1, whereas, at the time of parking exit, the route specifying unit 133 determines whether or not a pick-up request has been received from a user terminal device. In response to determining that a pick-up request has been received from the user terminal device, the route specifying unit 133 specifies a route from the parking area 5, where the vehicle 200 is currently parked, to the boarding location 6. Thereafter, the processing from Step S13 onward at the time of parking entry is executed.

### Advantageous Effects

As described above, according to the present embodiment, the vehicle guidance system 100 includes the communication unit 140, the parking lot sensor 110, the database 120, and the ECU 130. The ECU 130 includes the accuracy determination unit 131, the setting unit 132, and the route specifying unit 133. The accuracy determination unit 131 determines, out of the monitoring devices for monitoring the vehicle 200, the detection accuracy of the first monitoring device which is set as the active monitoring device for monitoring deviation of the vehicle 200 during autonomous driving along a route section. In response to determining that the detection accuracy of the camera 111 (the first monitoring device) is lower than the reference accuracy, the setting unit 132 sets, as the new active monitoring device, the second monitoring device. The second monitoring device is a monitoring device different from the camera 111 as the first monitoring device, and is one sensor out of the parking lot sensors 110 and on-board sensors 210.

Accordingly, when the detection accuracy of the camera 111 is determined to be lower than the reference accuracy, the deviation of the vehicle 200 during autonomous driving can be monitored by another sensor out of the other parking lot sensors 110 or on-board sensors 210, each being other than the camera 111 whose detection accuracy has decreased. Therefore, with the present embodiment, the accuracy of the monitoring can be improved. If the camera 111 is used to monitor deviation of the autonomously driving vehicle 200 when the detection accuracy of this camera 111 is lower than the reference accuracy, there may be a possibility that the deviation cannot be detected. According to the vehicle guidance system 100 of the present embodiment, such issues can be resolved, and a vehicle guidance system capable of suitably detecting such deviation can be implemented.

Also, according to this embodiment, upon detecting the deviation of the vehicle 200 which is moving along the route, the route specifying unit 133 specifies a solution route to resolve the deviation of the vehicle 200. Accordingly, the vehicle 200 is able to resolve the deviation by following this solution route.

Moreover, according to the present embodiment, the route specified by the route specifying unit 133 is divided into multiple sections, and information about the route is transmitted to the vehicle 200 for each divided section. Accordingly, the vehicle 200 does not need to have information necessary to park, and can reach the target position by moving along the route for each received section. Although the vehicle 200 is capable of moving autonomously while following a section of a given route section, the vehicle 200 will likely not be able to move autonomously along the entire route at once. According to the present embodiment, even such a vehicle 200 can be suitably guided.

### Other Embodiments

In the foregoing embodiment, the accuracy determination unit 131 determines the detection accuracy of the camera 111, whereas the accuracy determination unit 131 may also determine the detection accuracy of sensors other than the camera 111 (the first monitoring device). For example, in response to determining that the detection accuracy of the camera 111 is lower than the reference accuracy, the detection accuracy of sensors other than the camera 111 may be determined, and one sensor may be selected by the setting unit 132 from among the sensors whose detection accuracy is equal to or larger than the reference accuracy. The setting unit 132 may also select the sensor with the highest detection accuracy. Thus, by causing the accuracy determination unit 131 to also determine the detection accuracy of sensors other than the camera 111 (the first monitoring device), the deviation of the vehicle 200 during autonomous driving can be detected more appropriately.

Moreover, in the foregoing embodiment, the accuracy determination unit 131 determines the detection accuracy of the camera 111, and when the detection accuracy is lower than the reference accuracy, the setting unit 132 selects one sensor out of sensors other than the camera 111. The embodiment of the present disclosure is not limited to or by this configuration. In other words, the “first monitoring device” in the patent claims is not limited to the camera 111. When the accuracy determination unit 131 determines the detection accuracy of a sensor other than the camera 111, for example, the sonar 113, and, in response to determining that the detection accuracy of the sonar 113 is lower than the reference accuracy, the setting unit 132 may select one sensor out of the parking lot sensor 110 and the on-board sensor 210, which is different from the sonar 113.

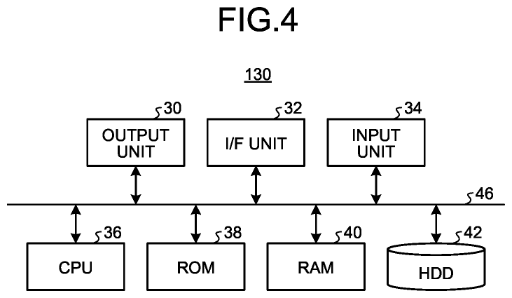

FIG. 4 is an example of a hardware configuration diagram of the ECU 130 of the vehicle guidance system 100 according to the present embodiment.

The ECU 130 of the foregoing embodiment includes: a control device such as a CPU 36; a storage device such as a ROM 38, a RAM 40, and an HDD 42; an I/F unit 32 which is an interface with various equipment; an output unit 30 which outputs various information such as output information; an input unit 34 which accepts operations by the user; and a bus 46 which connects each of the units. The ECU 130 has a hardware configuration for which an ordinary computer is utilized.

In the ECU 130 of the foregoing embodiment, each of the foregoing units is implemented on a computer by that the CPU 36 reads a program from the ROM 38 onto the RAM 40 and executes the program.

Note that the program for executing each of the foregoing processing performed by the ECU 130 in the foregoing embodiment may also be stored in the HDD 42. The program for executing each of the foregoing processing performed by the ECU 130 of the foregoing embodiment may also be provided pre-embedded in the ROM 38.

Additionally, the program for executing the foregoing processing performed by the ECU 130 of the foregoing embodiment may be provided as a computer program product by being stored on a computer-readable storage medium such as a CD-ROM, CD-R, memory card, DVD (Digital Versatile Disk), or flexible disk (FD) in a file which is in an installable format or an executable format. The program for executing the foregoing processing performed by the ECU 130 of the foregoing embodiment may also be stored on a computer connected to a network such as the Internet and provided by being downloaded over a network. Moreover, the program for executing the foregoing processing performed by the ECU 130 of the foregoing embodiment may also be provided or distributed over a network such as the Internet.

Note that, while an embodiment of the present invention has been described above, the foregoing embodiment is presented as an example and is not intended to limit the scope of the invention. New embodiments may be carried out in a variety of other forms, and various omissions, substitutions, and modifications can be made without departing from the spirit of the invention. Such embodiments and modifications thereof are incorporated in the scope and spirit of the invention and are incorporated in the scope of the inventions set forth in the patent claims and their equivalents.

### Supplementary Note

The present disclosure includes the following aspects. Hereinafter, the reference signs are in parentheses only to clarify correspondence with the embodiment.

The vehicle guidance system (100) according to a first aspect includes the route determination unit (133), the communication unit (140), the accuracy determination unit (131), and the setting unit (132). The route determination unit (133) specifies, outside the vehicle (200), a route from the starting position to the target position in a parking lot. The communication unit (140) transmits, to the vehicle (200) over the communication network, information about at least one route section of the route. The accuracy determination unit (131) determines detection accuracy of a first monitoring device being set as an active monitoring device out of monitoring devices each monitoring the vehicle (200), the active monitoring device serving to monitor deviation of the vehicle (200) from the route section during autonomous driving along the route section. In response to determining that the detection accuracy of the first monitoring device is lower than the reference accuracy, the setting unit (132) sets a second monitoring device as the active monitoring device in place of the first monitoring device, the second monitoring device being different from the first monitoring device among the monitoring devices. According to the first aspect, the vehicle (200) can continue to be monitored by another monitoring device even when the detection accuracy of the first monitoring device deteriorates. Hence, deviation of the vehicle (200) can be monitored more appropriately.

A vehicle guidance system (100) according to a second aspect can be implemented in combination with the first aspect. According to the second aspect, in response to determining that the detection accuracy of the first monitoring device is lower than the reference accuracy, the accuracy determination unit (131) specifies a factor causing the detection accuracy of the first monitoring device to be lower than the reference accuracy. The setting unit (132) sets the second monitoring device as the active monitoring device on the basis of the specified factors. According to the second aspect, the second monitoring device can be set on the basis of the factors of deterioration of the detection accuracy of the first monitoring device, and the second monitoring device can be selected more appropriately. Hence, deviation of the vehicle (200) can be monitored more appropriately.

A vehicle guidance system (100) according to a third aspect can be implemented in combination with the second aspect. According to the third aspect, the second monitoring device is a monitoring device (110) provided in a parking lot or a monitoring device (210) provided in the vehicle (200). The setting unit (132) sets, on the basis of the specified factor, the second monitoring device as the active monitoring device out of the monitoring devices (110, 210) each being provided in the parking lot or provided in the vehicle (200). According to the third aspect, the second monitoring device can be set on the basis of the factors of deterioration of the detection accuracy of the first monitoring device, and the second monitoring device can be selected more appropriately. Hence, deviation of the vehicle (200) can be monitored more appropriately.

A vehicle guidance system (100) according to a fourth aspect can be implemented in combination with any one of the first to third aspects. According to the fourth aspect, the accuracy determination unit (131) further determines the detection accuracy of a monitoring device different from the first monitoring device. The setting unit (132) sets the second monitoring device as the active monitoring device on the basis of the determined detection accuracy of the monitoring device. According to the fourth aspect, the second monitoring device can be set as the active monitoring device on the basis of the detection accuracy of the monitoring device provided separately from the first monitoring device, and the second monitoring device can be selected more appropriately. Hence, deviation of the vehicle (200) can be monitored more appropriately.

A vehicle guidance system (100) according to a fifth aspect can be implemented in combination with any one of the first to fourth aspects. According to the fifth aspect, when an illuminance around the first monitoring device is lower than a first set value, the accuracy determination unit (131) determines that the detection accuracy of the first monitoring device is lower than the reference accuracy. According to the fifth aspect, the detection accuracy of the first monitoring device can be determined more appropriately. Hence, deviation of the vehicle (200) can be monitored more appropriately.

A vehicle guidance system (100) according to a sixth aspect can be implemented in combination with any one of the first to fifth aspects. According to the sixth aspect, when a predetermined condition is satisfied on the basis of weather information about the parking lot, the accuracy determination unit (131) determines that the detection accuracy of the first monitoring device is lower than the reference accuracy. According to the sixth aspect, the detection accuracy of the first monitoring device can be determined more appropriately. Hence, deviation of the vehicle (200) can be monitored more appropriately.

A vehicle guidance system (100) according to a seventh aspect can be implemented in combination with the sixth aspect. According to the seventh aspect, when it is raining or snowing, or when fog is present, the accuracy determination unit (131) determines that the predetermined condition is satisfied. According to the seventh aspect, the detection accuracy of the first monitoring device can be determined more appropriately. Hence, deviation of the vehicle (200) can be monitored more appropriately.

A vehicle guidance system (100) according to an eighth aspect can be implemented in combination with any one of the first to seventh aspects. According to the eighth aspect, when an amount of shift in a detection direction of the first monitoring device is larger than a second set value, the accuracy determination unit (131) determines that the detection accuracy of the first monitoring device is lower than the reference accuracy. According to the eighth aspect, the detection accuracy of the first monitoring device can be determined more appropriately. Hence, deviation of the vehicle (200) can be monitored more appropriately.

A vehicle guidance system (100) according to a ninth aspect can be implemented in combination with any one of the first to eighth aspects. According to the ninth aspect, when dirt on a detection face of the first monitoring device covers a portion of the detection face larger than a given percentage, the accuracy determination unit (131) determines that the detection accuracy of the first monitoring device is lower than the reference accuracy. According to the ninth aspect, the detection accuracy of the first monitoring device can be determined more appropriately. Hence, deviation of the vehicle (200) can be monitored more appropriately.

A vehicle guidance system (100) according to a tenth aspect can be implemented in combination with any one of the first to ninth aspects. According to the tenth aspect, when an amount of shake of the first monitoring device is larger than a third set value, the accuracy determination unit (131) determines that the detection accuracy of the first monitoring device is lower than the reference accuracy. According to the tenth aspect, the detection accuracy of the first monitoring device can be determined more appropriately. Hence, deviation of the vehicle (200) can be monitored more appropriately.

A vehicle guidance system (100) according to an eleventh aspect can be implemented in combination with any one of the first to tenth aspects. According to the eleventh aspect, when the first monitoring device is failing, the accuracy determination unit (131) determines that the detection accuracy of the first monitoring device is lower than the reference accuracy. According to the eleventh aspect, the detection accuracy of the first monitoring device can be determined more appropriately. Hence, deviation of the vehicle (200) can be monitored more appropriately.

A vehicle guidance system (100) according to a twelfth aspect can be implemented in combination with any one of the first to eleventh aspects. According to the twelfth aspect, when a deviation is identified by the first monitoring device, the route specifying unit (133) specifies a solution route to resolve the deviation. The communication unit (140) transmits the solution route to the vehicle (200) over the communication network. According to the twelfth aspect, a solution route for the deviation can be transmitted to the vehicle (200), and the deviation can be resolved by the vehicle (200) driving along the solution route.

A vehicle guidance method according to a thirteenth aspect includes a route specifying step (S12), a communication step (S13), an accuracy determination step (S14), and a setting step (S15). The route specifying step specifies, outside the vehicle, a route from the starting position to the target position in the parking lot. The communication step transmits, to the vehicle over the communication network, information about at least one route section of the route. The accuracy determination step determines detection accuracy of a first monitoring device being set as an active monitoring device out of monitoring devices each monitoring the vehicle, the active monitoring device serving to monitor deviation of the vehicle from the route section during autonomous driving along the route section. In response to determining that the detection accuracy of the first monitoring device is lower than the reference accuracy, the setting step sets a second monitoring device as the active monitoring device in place of the first monitoring device, the second monitoring device being different from the first monitoring device among the monitoring devices. According to the twelfth aspect, the vehicle (200) can continue to be monitored by another monitoring device even when the detection accuracy of the first monitoring device deteriorates. Hence, deviation of the vehicle (200) can be monitored more appropriately.

The vehicle guidance system according to the present disclosure is capable of appropriately detecting deviation of a vehicle during autonomous driving.

What is claimed is:

1. A vehicle guidance system comprising:
a hardware processor configured to
specify, outside a vehicle, a route from a starting position to a target position in a parking lot,
transmit, to the vehicle over a communication network, information about at least one route section of the route,
determine detection accuracy of a first monitoring device being set as an active monitoring device out of monitoring devices each monitoring the vehicle, the active monitoring device serving to monitor deviation of the vehicle from the route section during autonomous driving along the route section, and,
in response to determining that the detection accuracy of the first monitoring device is lower than a reference accuracy, set a second monitoring device as the active monitoring device in place of the first monitoring device, the second monitoring device being different from the first monitoring device among the monitoring devices.

2. The vehicle guidance system according to claim 1, wherein, in response to determining that the detection accuracy of the first monitoring device is lower than the reference accuracy, the hardware processor
specifies a factor causing the detection accuracy of the first monitoring device to be lower than the reference accuracy, and
sets the second monitoring device as the active monitoring device on the basis of the specified factor.

3. The vehicle guidance system according to claim 2, wherein
the monitoring devices includes one or more parking lot monitoring devices provided in the parking lot and one or more on-board monitoring devices provided in the vehicle, and
the hardware processor sets, on the basis of the specified factor, the second monitoring device as the active monitoring device out of the one or more parking lot monitoring devices and the one or more on-board monitoring devices.

4. The vehicle guidance system according to claim 1, wherein the hardware processor
determines the detection accuracy of the monitoring device other than the first monitoring device, and
sets the second monitoring device as the active monitoring device on the basis of the determined detection accuracy of the monitoring device.

5. The vehicle guidance system according to claim 1, wherein, when an illuminance around the first monitoring device is lower than a first set value, the hardware processor determines that the detection accuracy of the first monitoring device is lower than the reference accuracy.

6. The vehicle guidance system according to claim 1, wherein, when a predetermined condition is satisfied on the basis of weather information about the parking lot, the hardware processor determines that the detection accuracy of the first monitoring device is lower than the reference accuracy.

7. The vehicle guidance system according to claim 6, wherein, when it is raining or snowing, or when fog is present, the hardware processor determines that the predetermined condition is satisfied.

8. The vehicle guidance system according to claim 1, wherein, when an amount of shift in a detection direction of the first monitoring device is larger than a second set value, the hardware processor determines that the detection accuracy of the first monitoring device is lower than the reference accuracy.

9. The vehicle guidance system according to claim 1, wherein, when dirt on a detection face of the first monitoring device covers a portion of the detection face larger than a given percentage, the hardware processor determines that the detection accuracy of the first monitoring device is lower than the reference accuracy.

10. The vehicle guidance system according to claim 1, wherein, when an amount of shake of the first monitoring device is larger than a third set value, the hardware processor determines that the detection accuracy of the first monitoring device is lower than the reference accuracy.

11. The vehicle guidance system according to claim 1, wherein, when the first monitoring device is failing, the hardware processor determines that the detection accuracy of the first monitoring device is lower than the reference accuracy.

12. The vehicle guidance system according to claim 1, wherein, when a deviation is identified by the first monitoring device, the hardware processor specifies a solution route to resolve the deviation and transmits the solution route to the vehicle over the communication network.

13. A vehicle guidance method comprising:
specifying, outside a vehicle, a route from a starting position to a target position in a parking lot;
transmitting, to the vehicle over a communication network, information about at least one route section of the route;
determining detection accuracy of a first monitoring device being set as an active monitoring device out of monitoring devices each monitoring the vehicle, the active monitoring device serving to monitor deviation of the vehicle from the route section during autonomous driving along the route section; and,
in response to determining that the detection accuracy of the first monitoring device is lower than a reference accuracy, setting a second monitoring device as the active monitoring device in place of the first monitoring device, the second monitoring device being different from the first monitoring device among the monitoring devices.
